(19) United States
(12) Patent Application Publication
(10) Pub. No.: US 2017/0170696 A1
(43) Pub. Date: Jun. 15, 2017

(54) MOTOR

(71) Applicant: Panasonic Intellectual Property Managemnet Co., Ltd., Osaka (JP)

(72) Inventors: TAKASHI OGAWA, Osaka (JP); YUICHI YOSHIKAWA, Osaka (JP); HARUHIKO KADO, Osaka (JP); YUKIHIRO OKADA, Osaka (JP); YUSUKE OKUMURA, Osaka (JP)

(21) Appl. No.: 15/325,517

(22) PCT Filed: Sep. 2, 2015
(86) PCT No.: PCT/JP2015/004451

§ 371 Date: Jan. 11, 2017

(30) Foreign Application Priority Data
Sep. 16, 2014 (JP) 2014-187368

(51) Int. Cl. H02K 1/27; H02K 29/03; H02K 21/14

(52) U.S. Cl. CPC H02K 1/2766; H02K 21/14; H02K 1/2773; H02K 29/03; H02K 2213/03

(57) ABSTRACT

Motor according to the present invention includes rotor core and rotor. Rotor core includes outer circumferential surface formed along shaft center, and a plurality of magnet holes. Each of magnet holes has a convex surface located on a side of rotary shaft and a concave surface located on a side of outer circumferential surface. α1 is a distance between the convex surface and the concave surface on an end part located on the side of outer circumferential surface. β1 is a distance between the convex surface and the concave surface on a central part located on the side of rotary shaft. In magnet hole, α1 is larger than β1. Bonded magnets are filled in magnet holes. α2 is a thickness of a magnet component located on the end part in an oriented direction of the magnet component. β2 is a thickness of a magnet component located on the central part in an oriented direction of the magnet component. In each of the plurality of bonded magnets, α2 is larger than β2.

### TECHNICAL FIELD

The present invention relates to a motor including an interior permanent magnet rotor provided with a plurality of permanent magnets in a rotor core.

### BACKGROUND ART

Conventionally, a motor using a permanent magnet includes a rotor provided on an inner circumference of a stator with a gap interposed between the rotor and the stator.

The stator has substantially a cylindrical shape, and generates a rotating magnetic field.

The rotor includes a rotary shaft and a rotor core. The rotor rotates around the rotary shaft. A magnet hole into which a permanent magnet is inserted is formed on the rotor core. A magnetic pole is formed on the rotor by the permanent magnet inserted into the rotor core.

A motor in which a permanent magnet is embedded into a rotor core as in the configuration described above is also referred to as an interior permanent magnet (IPM) motor.

A small piece of an Nd—Fe—B sintered magnet or a small piece of a ferrite sintered magnet has been widely used for a permanent magnet.

In the case where a small piece of a permanent magnet is used, a magnet hole formed on a rotor core is formed with a size slightly larger than the outer shape of the small piece of the permanent magnet. If the magnet hole has a size slightly larger than the outer shape of the small piece of the permanent magnet, workability in assembling the rotor is enhanced. The reason of the enhancement in workability is as stated below.

Specifically, the magnet hole formed on the rotor core is formed through a process for working a metal. The process for working a metal is referred to as a metal working process below. Therefore, the magnet hole is formed with high-precise working, and thus, a dimensional tolerance is small.

On the other hand, the small piece of the permanent magnet described above is formed through a process for sintering magnet powders or the like. The process for sintering magnet powders or the like is referred to as a sintering process below. The sintering process is similar to a process for firing ceramics or the like in a kiln. Accordingly, a small piece of a permanent magnet which has been subjected to the sintering process may sometimes be deformed, for example, may be warped or bent. If the small piece of the permanent magnet is subjected to a process for grinding the small piece with a grind stone or the like, the deformation occurring on the small piece of the permanent magnet can be eliminated. The process for grinding the small piece with a grind stone or the like is referred to as a grinding process below.

A motor does not employ a grinding process for eliminating deformation on a small piece of a permanent magnet. Alternatively, even if a grinding process is employed for a motor, an amount to be ground of a small piece of a permanent magnet is very small. In addition, precision in grinding a small piece of a permanent magnet is low.

Accordingly, as described above, a motor addresses deformation on a small piece of a permanent magnet by setting a magnet hole to be slightly larger than the outer shape of the small piece of the permanent magnet. It is to be noted that, when the grinding process is employed, the following problems arise. Specifically, the problems include the need of facility and an increase in the number of working processes.

However, in the case where the magnet hole is set to be slightly larger than the outer shape of the small piece of the permanent magnet, a gap is generated between the rotor core and the small piece of the permanent magnet. The gap between the rotor core and the small piece of the permanent magnet acts as magnetic resistance. Therefore, magnetic flux density generated on the surface of the rotor decreases.

Further, a small piece of a permanent magnet formed from an Nd—Fe—B sintered magnet or a ferrite sintered magnet has characteristics of being hard and fragile, like ceramics. In view of this, a small piece of a permanent magnet cannot be formed to have a complex shape.

Specifically, the following shape is employed for a small piece of a permanent magnet. That is, a small piece of a permanent magnet is a columnar body with a rectangular cross-section. The columnar body with a rectangular cross-section is a planar plate. Alternatively, a small piece of a permanent magnet is a columnar body with a trapezoidal cross-section. A small piece of a permanent magnet is a columnar body with an arc cross-section. The columnar body with an arc cross-section is a plate having substantially a U shaped cross section.

Any of the small pieces of permanent magnets formed through the above molding process has a large dimension tolerance. Therefore, when the small pieces of the permanent magnets are used, a gap is formed between the rotor core and the used small piece of the permanent magnet.

To address this problem, PTL 1 discloses an interior permanent magnet rotor including a bonded magnet in a magnet hole. The bonded magnet is formed by filling a mixture constituting the bonded magnet into the magnet hole. The mixture constituting the bonded magnet includes magnet powders, resin material, and a small amount of additives. The mixture constituting the bonded magnet is used in the state in which magnet powders, resin material, and a small amount of additives are melted. The bonded magnet is molded in such a way that, after the mixture constituting the bonded magnet is filled in the magnet hole, a process such as a pressurizing process is performed. The process for molding the bonded magnet is referred to as a molding process below.

Particularly in the case where thermosetting resin is used as the resin material, the molding process includes the following processes. Specifically, the molding process includes a heating process for heating the mixture and melting the heated mixture. Since a thermosetting reaction is caused in the heated mixture, the mixture is cured. The cured mixture is cooled through a cooling process. The cooled mixture constitutes the bonded magnets.

In addition, in the case where thermoplastic resin is used as the resin material, the molding process includes the following processes. Specifically, the molding process includes a heating process for heating the mixture and melting the heated mixture. The heated mixture is cooled through a cooling process. The cooled mixture is re-cured to constitute the bonded magnets.

Note that, in the description below, a mixture constituting a bonded magnet is also referred to as a bonded magnet in some cases.

According to this configuration, the bonded magnet is filled without a gap along the shape of the magnet hole formed on the rotor core. Since there is no gap generated between the rotor core and the bonded magnet, the reduction in a magnetic flux generated on the rotor is suppressed.

Further, PTL 2 discloses a manufacturing method of an interior permanent magnet rotor using an insert die having a plurality of gates. The gate is an inlet opening from which a bonded magnet is inserted. In PTL 2, a mixture constituting a bonded magnet is inserted from both ends of a magnet hole using the above-mentioned insert die.

### CITATION LIST

### Patent Literature

PTL 1: Unexamined Japanese Patent Publication No. H10-304610

PTL 2: Unexamined Japanese Patent Publication No. 2013-121240

### SUMMARY OF THE INVENTION

A motor according to the present invention includes a stator and a rotor.

The stator includes a winding through which a drive current flows and a stator core around which the winding is wound.

The rotor includes a rotary shaft, a rotor core, and a plurality of bonded magnets.

The rotor core is mounted to the rotary shaft to form a columnar body in a direction of a shaft center of the rotary shaft. The rotor core includes an outer circumferential surface formed along the shaft center, and a plurality of magnet holes. Each of the plurality of magnet holes is located along the outer circumferential surface. Each of the plurality of magnet holes has a convex surface located on a side of the rotary shaft and a concave surface located on a side of the outer circumferential surface. Each of the plurality of magnet holes has a shape of projecting from the outer circumferential surface toward a position where the rotary shaft is located. Here, α1 is a distance between the convex surface and the concave surface on an end part located on the side of the outer circumferential surface. β1 is a distance between the convex surface and the concave surface on a central part located on the side of the rotary shaft. In each of the plurality of magnet holes, α1 is larger than β1.

Each of the plurality of bonded magnets is filled in each of the magnet holes. Here, α2 is a thickness of a magnet component located on the end part in an oriented direction of the magnet component. β2 is a thickness of a magnet component located on the central part in an oriented direction of the magnet component. In each of the plurality of bonded magnets, α2 is larger than β2.

In addition, the rotor has a plurality of d-axis magnetic flux paths and a plurality of q-axis magnetic flux paths. A plurality of d-axis magnetic flux paths generates magnet torque out of rotary torques generated on the rotor due to a rotating magnetic field generated by the stator, when a drive current flows through the winding. Similarly, a plurality of q-axis magnetic flux paths generates reluctance torque out of rotary torques.

Each of the d-axis magnetic flux paths is located to cross each of the plurality of bonded magnets. Each of the q-axis magnetic flux paths is located along each of the plurality of bonded magnets.

### BRIEF DESCRIPTION OF DRAWINGS

FIG. 1 is a perspective assembly view of a main part constituting a motor according to an exemplary embodiment of the present invention.

FIG. 2 is a flowchart illustrating an assembly process of the main part constituting the motor according to the exemplary embodiment of the present invention.

FIG. 3 is a sectional view illustrating the motor according to the exemplary embodiment of the present invention.

FIG. 4 is an explanatory view for describing a path of a magnetic flux generated on a rotor used in the motor according to the exemplary embodiment of the present invention.

FIG. 5 is an enlarged view of a key part of the motor illustrated in FIG. 3.

FIG. 6 is another enlarged view of the key part of the motor illustrated in FIG. 3.

FIG. 7 is another enlarged view of the key part of the motor illustrated in FIG. 3.

FIG. 8 is a sectional view along line 8-8 in FIG. 7.

FIG. 9 is another enlarged view of the key part of the motor illustrated in FIG. 3.

FIG. 10 is a graph illustrating characteristics relating to a distance of a mixture constituting a bonded magnet filled in a magnet hole from a gate position and a density of a cured bonded magnet in the interior permanent magnet rotor used in the motor according to the exemplary embodiment of the present invention.

### DESCRIPTION OF EMBODIMENT

A motor according to the exemplary embodiment of the present invention can suppress deterioration in magnetic characteristics at low cost without increasing the size of the motor by the configuration described below.

Specifically, there is the problem described below in employing the bonded magnet disclosed in PTL 1 in an interior permanent magnet rotor used in a conventional motor by using the manufacturing method disclosed in PTL 2. That is, a mixture filled in each of magnet holes from both ends thereof to constitute a bonded magnet generates a flow toward the central part of each magnet hole. The mixture filled from both ends of each magnet hole forms a weld on the location where the flows of the bonded magnet merge. The mixture cured through a molding process constitutes the bonded magnet in the state of including the weld. Therefore, in the bonded magnet manufactured by the manufacturing process described above, the magnetic characteristics are deteriorated on the central part of the magnet hole where the weld occurs.

In view of this, the motor according to the exemplary embodiment of the present invention is configured to allow a mixture constituting a bonded magnet to easily flow by the configuration described below, thereby being capable of suppressing the reduction in the density of the bonded magnet. Therefore, even if a mixture constituting a bonded magnet is filled from a central part of a magnet hole, the motor can suppress deterioration in magnetic characteristics of the bonded magnet on an end part of the magnet hole.

In addition, in the motor according to the exemplary embodiment of the present invention, only a thickness α2 on a magnet end part, which is located on a position distant from a position where a gate is located and which is included in the bonded magnet, is set large. The present configuration can prevent a large increase in an amount of a material to be used for forming a bonded magnet. Thus, an inexpensive motor can be provided without increasing the size of the motor.

An exemplary embodiment of the present invention will be described below with reference to the drawings. Note that the exemplary embodiment described below is merely illustrative of implementing the present invention, and not restrictive of the technical scope of the present invention.

### EXEMPLARY EMBODIMENT

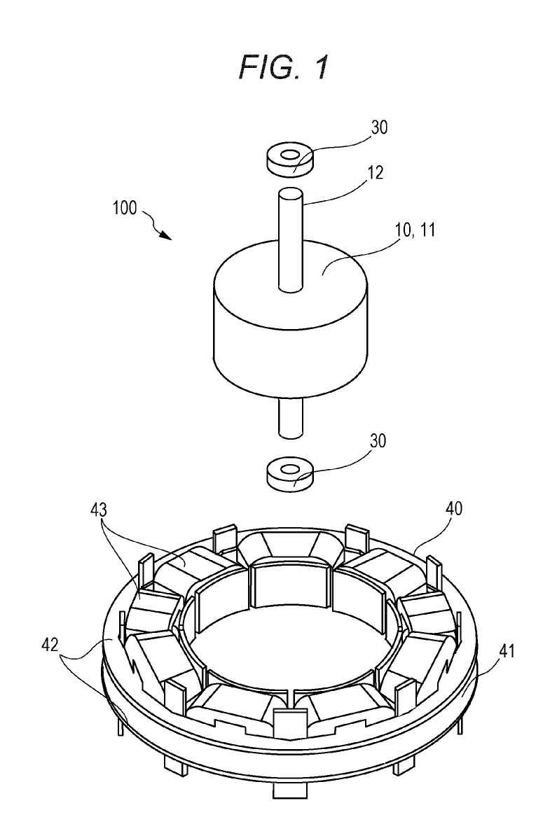

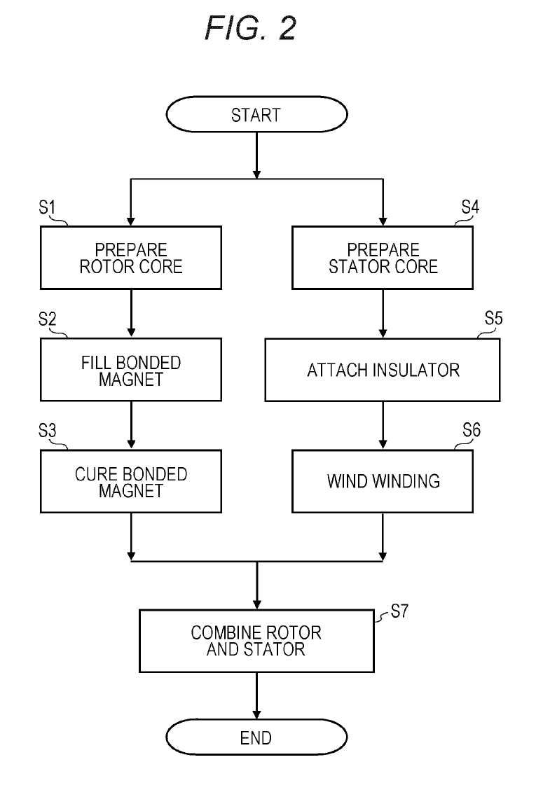

FIG. 1 is a perspective assembly view of a main part constituting a motor according to an exemplary embodiment of the present invention. FIG. 2 is a flowchart illustrating an assembly process of the main part constituting the motor according to the exemplary embodiment of the present invention.

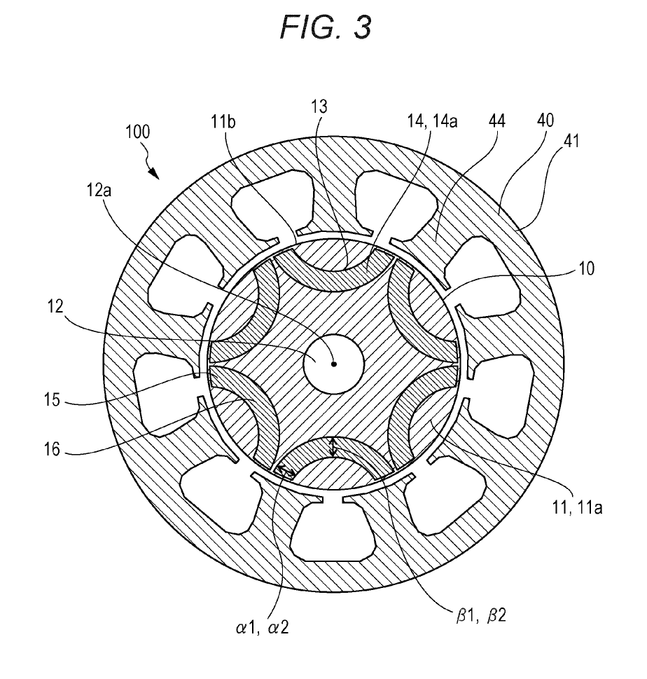

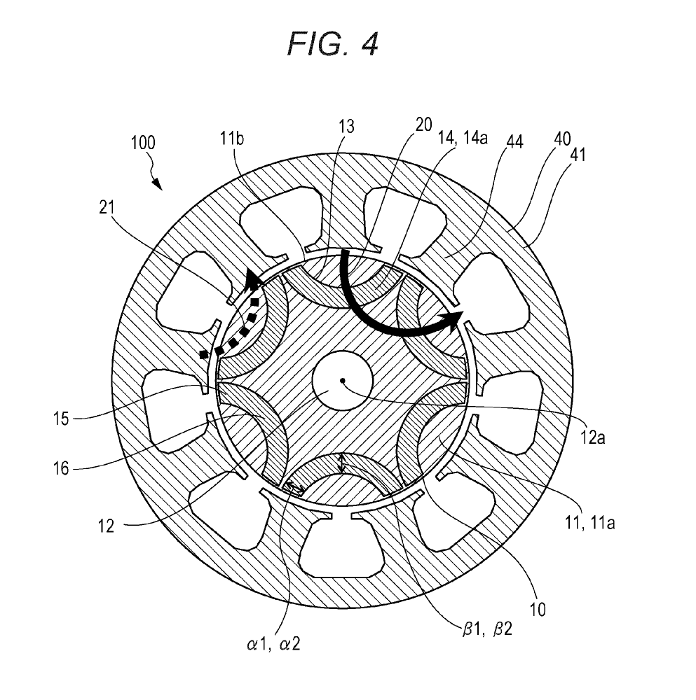

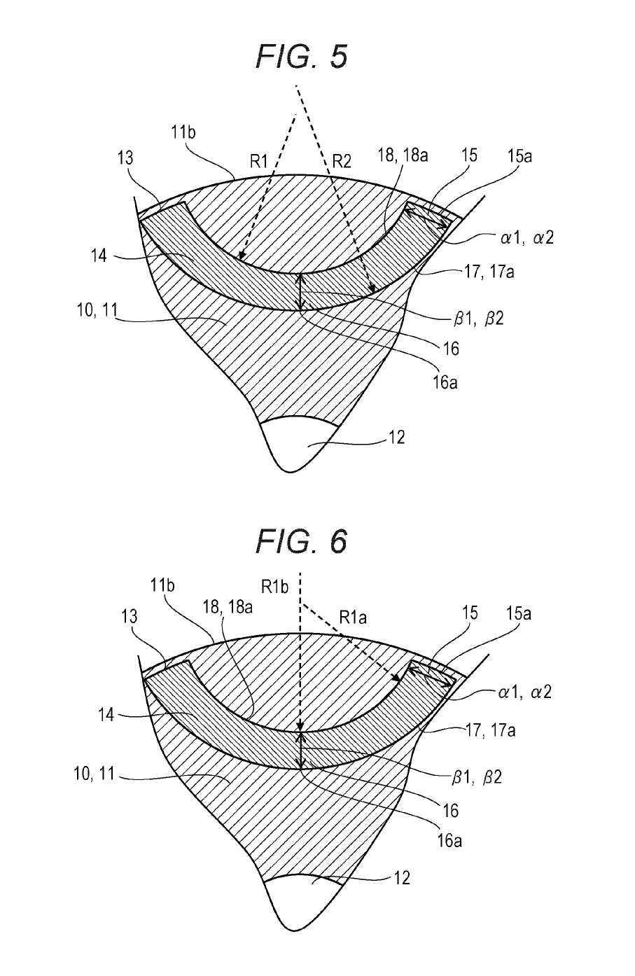

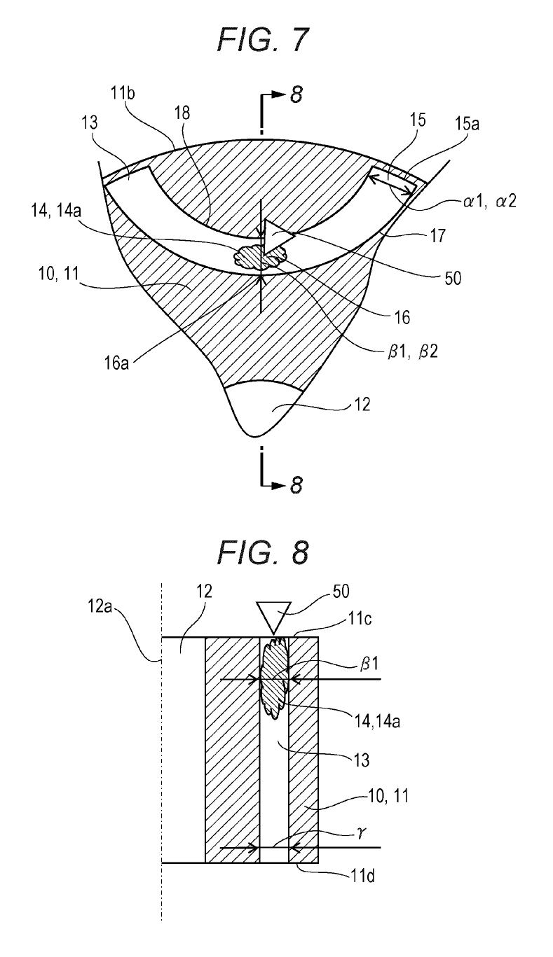

In addition, FIG. 3 is a sectional view illustrating the motor according to the exemplary embodiment of the present invention. FIG. 4 is an explanatory view for describing a path of a magnetic flux generated on a rotor used in the motor according to the exemplary embodiment of the present invention. FIG. 5 is an enlarged view of a key part of the motor illustrated in FIG. 3. FIGS. 6, 7, and 9 are each another enlarged view of the key part of the motor illustrated in FIG. 3. FIG. 8 is a sectional view along line 8-8 in FIG. 7.

In addition, FIG. 10 is a graph illustrating characteristics relating to a distance of a mixture constituting a bonded magnet filled in a magnet hole from a gate position and a density of a cured bonded magnet in the interior permanent magnet rotor used in the motor according to the exemplary embodiment of the present invention.

Firstly, one example of a process of assembling motor 100 according to the exemplary embodiment of the present invention will briefly be described with reference to FIGS. 1 and 2.

As illustrated in FIG. 1, motor 100 according to the present exemplary embodiment includes interior permanent magnet rotor 10 and stator 40. In the description below, interior permanent magnet rotor 10 is merely referred to as rotor 10 in some cases.

As illustrated in FIG. 2, rotor 10 and stator 40 are simultaneously prepared.

Firstly, rotor core 11 is prepared for rotor 10 (S1). Thin steel plates constituting rotor core 11 are punched by a die. Each of the steel plates is punched by a die to form a magnet hole. Rotary shaft 12 is inserted into each of a plurality of steel plates punched out by the die. The plurality of steel plates is laminated along the shaft center of rotary shaft 12 to form rotor core 11.

Then, a mixture constituting a bonded magnet is filled in a magnet hole formed on rotor core 11 (S2). The mixture constituting the bonded magnet is used in the state in which magnet powders, resin material, and a small amount of additives are melted. The mixture constituting the bonded magnet is filled in the magnet hole from a gate included in an insert die.

The mixture filled in rotor 10 is cured through a molding process to constitute a bonded magnet. During the molding process, a process according to the characteristic of the resin material included in the mixture is performed (S3).

On the other hand, stator core 41 is prepared for stator 40 (S4). As in rotor core 11, stator core 41 is formed by laminating thin steel plates. Insulator 42 which is an insulating member is attached to stator core 41 (S5).

Next, a winding 43 through which a current is to flow is wound around stator core 41 to which insulator 42 is attached (S6).

Rotor 10 and stator 40, which are individually prepared, are combined to each other (S7). As illustrated in FIG. 3, motor 100 according to the present exemplary embodiment includes rotor 10 inserted into stator 40 on an inner circumferential side with a gap interposed between rotor 10 and stator 40. The main part of motor 100 will be described later. As illustrated in FIG. 1, when rotor 10 is inserted into stator 40, a pair of bearings 30 is attached to rotary shaft 12 of rotor 10. Rotor 10 is rotatably supported by a pair of bearings 30.

Next, the motor according to the exemplary embodiment of the present invention will be described in detail with reference to FIGS. 3 to 10. In the description below, an interior permanent magnet rotor is employed as the rotor as one example.

As illustrated in FIG. 3, motor 100 according to the present exemplary embodiment includes stator 40 and rotor 10.

Stator 40 includes winding (43) through which a drive current flows and stator core 41 around which winding (43) is wound.

Rotor 10 includes rotary shaft 12, rotor core 11, and a plurality of bonded magnets 14.

Rotor core 11 is mounted to rotary shaft 12 to form a columnar body in a direction of shaft center 12a of rotary shaft 12. Rotor core 11 includes outer circumferential surface 11b formed along shaft center 12a, and a plurality of magnet holes 13. Each of the plurality of magnet holes 13 is located along outer circumferential surface 11b.

As illustrated in FIG. 5, each of the plurality of magnet holes 13 has convex surface 17a located on the side of rotary shaft 12 and concave surface 18a located on the side of outer circumferential surface 11b. Each of the plurality of magnet holes 13 has a shape of projecting from outer circumferential surface 11b toward the position where rotary shaft 12 is located. Here, α1 is a distance between convex surface 17a and concave surface 18a on end part 15a located on the side of outer circumferential surface 11b. β1 is a distance between convex surface 17a and concave surface 18a on central part 16a located on the side of rotary shaft 12. In each of the plurality of magnet holes 13, α1 is larger than β1.

Each of the plurality of bonded magnets 14 is filled in each of the plurality of magnet holes 13. Here, α2 is a thickness of a magnet component located on end part 15a in an oriented direction of the magnet component. β2 is a thickness of a magnet component located on central part 16a in an oriented direction of the magnet component. In each of the plurality of bonded magnets 14, α2 is larger than β2.

In addition, as illustrated in FIG. 4, rotor 10 has a plurality of d-axis magnetic flux paths 20 and a plurality of q-axis magnetic flux paths 21. The plurality of d-axis magnetic flux paths 20 generates magnet torque out of rotary torques generated on rotor 10 due to a rotating magnetic field generated by stator 40, when a drive current flows through windings (43). Similarly, the plurality of q-axis magnetic flux paths 21 generates reluctance torque out of rotary torques.

Each of d-axis magnetic flux paths 20 is located to cross each of the plurality of bonded magnets 14. Each of q-axis magnetic flux paths 21 is located along each of the plurality of bonded magnets 14.

Notably, in the present exemplary embodiment, bonded magnets 14 are filled in magnet holes 13. Therefore, α1 and β1 indicating the thickness of magnet hole 13 and α2 and β2 indicating the thickness of bonded magnet 14 have substantially the following relation. That is, α1=α2 and β1=β2 are established.

The motor providing particularly significant operation and effects is as stated below.

Specifically, as illustrated in FIGS. 3 and 5, in each of the plurality of bonded magnets 14, the density of the magnet on end part 15a is lower than the density of the magnet on central part 16a.

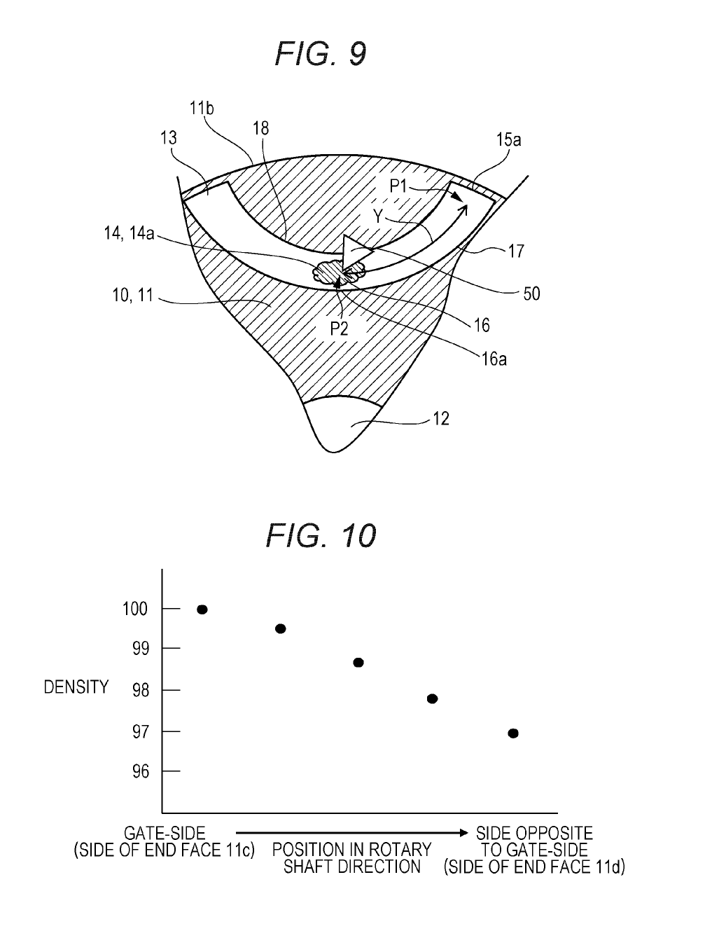

In addition, as illustrated in FIG. 9, bonded magnet 14 is further filled in each of the plurality of magnet holes 13 through an insert die. Bonded magnet 14 satisfies the following condition. Specifically, the density of bonded magnet 14 filled in point P1 is defined as X. The distance from point P2 where gate 50 included in the insert die is located to point P1 is defined as Y. The theoretical material density of bonded magnet 14 is defined as C. In this case, the decrease rate A of the density of bonded magnet 14 is represented by A=X/(Y×C). Further, in bonded magnet 14, thickness β2 of the magnet component located on magnet central part 16 in the oriented direction satisfies β2=A×α2. This configuration will be described later in detail.

In addition, as illustrated in FIG. 5, in bonded magnet 14, resistance to demagnetization D1 of magnet central part 16 located on central part 16a and resistance to demagnetization D2 of magnet end part 15 located on end part 15a are equal to each other. Notably, the state in which resistance to demagnetization D1 and resistance to demagnetization D2 are equal to each other means that they are equal to each other in practical usage. In other words, the state described above does not mean only the case where resistance to demagnetization D1 and resistance to demagnetization D2 exactly match each other. This configuration will be described later in detail.

Further, as illustrated in FIG. 5, each of the plurality of magnet holes 13 has an arc shape of projecting from outer circumferential surface 11b toward the position where rotary shaft 12 is located. In each of magnet holes 13, radius R1 of arc 18 included in concave surface 18a is shorter than radius R2 of arc 17 included in convex surface 17a.

In addition, as illustrated in FIG. 6, arc 18 included in concave surface 18a has two or more different curvatures 1/R1a and 1/R1b.

The interior permanent magnet rotor used in the motor according to the present exemplary embodiment will be described in more detail with reference to the drawings.

As illustrated in FIGS. 1 and 3, motor 100 includes rotor 10 and stator 40. Stator 40 has teeth 44 extending toward shaft center 12a of rotary shaft 12. Windings 43 are wound around teeth 44 of stator 40. A core wire including any one of copper, copper alloy, aluminum, and aluminum alloy can be used for a core wire included in each of windings 43.

Rotor 10 includes rotor core 11, a plurality of magnet holes 13, and a plurality of bonded magnets 14. Rotor core 11 is formed by laminating steel plates 11a, which are punched out, in the direction of shaft center 12a of rotary shaft 12. Mixture (14a) constituting bonded magnets 14 is filled in magnet holes 13.

As illustrated in FIGS. 3 and 5, each bonded magnet 14 has an arc shape in which magnet central part 16 projects toward rotary shaft 12. Bonded magnet 14 has magnet end part 15 near outer circumferential surface 11b of rotor core 11. On magnet end part 15, the thickness of the magnet component in the oriented direction thereof is α2. On magnet central part 16, the thickness of the magnet component in the oriented direction thereof is β2. The thickness in the oriented direction of the magnet component is also referred to as a magnet thickness below. Magnet thickness α2 and magnet thickness β2 have the relation of α2>β2.

As illustrated in FIG. 5, bonded magnets 14 used in rotor 10 according to the present exemplary embodiment are configured as described below to establish the relation of α2>β2. Specifically, in each of bonded magnets 14, radius R1 of arc 18 included in concave surface 18a is shorter than radius R2 of arc 17 included in convex surface 17a.

Notably, as illustrated in FIG. 6, magnet thicknesses α2 and β2 can freely be set in bonded magnets 14 used in rotor 10 in the present exemplary embodiment according to the configuration described below.

Specifically, in each bonded magnet 14, the radius of arc 18 included in concave surface 18a includes two or more different curvatures 1/R1a and 1/R1b. That is, the radius of arc 18 included in concave surface 18a is formed by connecting arcs having different curvatures of 1/R1a and 1/R1b to each other.

Meanwhile, in the case where a mixture constituting a bonded magnet is filled from a central part of a magnet hole using a gate included in an insert die, problems described below may arise.

Specifically, there may be the case where the density of the bonded magnet obtained by curing the mixture constituting the bonded magnet is different between the location near the gate from which the mixture is inserted and the location distant from the gate. That is, the result similar to the case where the filling pressure for the mixture constituting the bonded magnet is lowered is obtained on the location distant from the gate, that is, on the magnet end part.

Consequently, the bonded magnet obtained by curing the mixture may have deterioration in magnetic characteristics on the portion having low density.

In view of this, as illustrated in FIGS. 7 and 8, the rotor used in the motor according to the present exemplary embodiment employs the configuration described below. Specifically, in magnet hole 13, a width of magnet end part 15 located on end part 15a is larger than a width of magnet central part 16 located on central part 16a.

According to this configuration, mixture 14a constituting bonded magnets 14 is filled in magnet holes 13 from gate 50 included in an insert die. In the present exemplary embodiment, mixture 14a constituting bonded magnets 14 is filled from central part 16a of each magnet hole 13. Mixture 14a to be filled to constitute bonded magnets 14 includes magnet powders, resin material, and a plurality of additives.

In this case, in rotor 10, magnet thickness α2 on magnet end part 15 located on end part 15a distant from gate 50 is larger than magnet thickness β2 on magnet central part 16 located on central part 16a where gate 50 is provided. Therefore, mixture 14a constituting bonded magnets 14 is easy to flow on end part 15a. Accordingly, the variation in density of mixture 14a constituting bonded magnets 14 is reduced more than conventionally in the region from central part 16a of magnet hole 13 to end part 15a of magnet hole 13. Since the variation in density of mixture 14a is reduced, an extreme density variation does not occur on bonded magnet 14 obtained by curing mixture 14a. Consequently, in bonded magnet 14, local deterioration in magnetic characteristics is not caused.

In addition, in the present configuration, only magnet thickness α2 on magnet end part 15 distant from gate 50 is set larger. Thus, the amount of the material to be used to constitute bonded magnet 14 can be decreased, in addition to the above-mentioned operation and effect. Accordingly, rotor 10 according to the present exemplary embodiment can suppress deterioration in magnetic characteristics at low cost without increasing the size of motor 100.

Specifically, the rotor used in the motor according to the present exemplary embodiment is configured to satisfy the following relation. That is, the decrease rate of the density of bonded magnet 14 is defined as A. In this case, bonded magnet 14 satisfies equation (1) with respect to magnet thickness α2 on magnet end part 15 and magnet thickness β2 on magnet central part 16.

β2=A×α2 (1)

Here, decrease rate A indicating the density of bonded magnet 14 is represented by the following equation. That is, as illustrated in FIG. 9, the density of bonded magnet 14 to be filled on arbitrary point P1 of magnet hole 13 is defined as X. The distance from point P2 where gate 50 is located to arbitrary point P1 is defined as Y. The theoretical material density of bonded magnet 14 is defined as C. In this case, decrease rate A is represented by equation (2).

A=X/(Y×C) (2)

Then, as illustrated in FIG. 8, mixture 14a constituting bonded magnet 14 is filled toward magnet hole 13 from end face 11c of rotor core 11 in the direction along shaft center 12a of rotary shaft 12. Mixture 14a constituting bonded magnet 14 is inserted from gate 50 included in an insert die.

As illustrated in FIG. 10, the density of bonded magnet 14 is lower on the side of end face 11d toward which mixture 14a constituting bonded magnet 14 is filled than on the side (side on end face 11c) where gate 50 is located. Note that the side of end face 11d is indicated as a side opposite to gate-side in FIG. 10.

As apparent from FIG. 10, the density of bonded magnet 14 obtained by curing mixture 14a becomes lower toward the side opposite to gate-side from the gate-side. The reason of this is considered, in principle, such that the filling pressure for mixture 14a constituting bonded magnet 14 is lowered in proportion to the distance to the gate.

In view of this, according to the rotor used in the motor according to the present exemplary embodiment, magnet thickness α2 on magnet end part 15 can be adjusted in proportion to the decrease rate of the density of bonded magnet 14. Specifically, magnet thickness α2 is set larger on magnet end part 15 where the density of bonded magnet 14 is lowered. Magnet thickness α2 may be increased in proportion to the decrease in the density of bonded magnet 14.

According to this configuration, fluidity of mixture 14a constituting bonded magnet 14 is enhanced. Therefore, in rotor 10 used in the motor according to the present exemplary embodiment, the density of bonded magnet 14 can be made uniform, regardless of the shape of magnet hole 13. Thus, rotor 10 can three-dimensionally suppress deterioration in magnetic characteristics.

Particularly, in rotor 10 used in the motor according to the present exemplary embodiment, magnet thickness γ on the side of end face 11d of magnet hole 13, at which the density of bonded magnet 14 obtained by curing mixture 14a is lowered, is increased, as illustrated in FIG. 8. Specifically, magnet thickness γ may be increased in proportion to the decrease rate of the density of bonded magnet 14.

According to this configuration, fluidity of mixture 14a constituting bonded magnet 14 is enhanced. Thus, in rotor 10 used in the motor according to the present exemplary embodiment, the variation in the density of mixture 14a is reduced more than conventionally in the region of magnet hole 13 from end face 11c located on the side of gate 50 to end face 11d located on the side opposite to gate 50, regardless of the shape of magnet hole 13. Since the variation in density of mixture 14a is reduced, an extreme density variation does not occur on bonded magnet 14 obtained by curing mixture 14a. Thus, rotor 10 can three-dimensionally suppress deterioration in magnetic characteristics.

In addition, as illustrated in FIG. 5, rotor 10 used in the motor according to the present exemplary embodiment satisfies the following relation with respect to magnet thickness α2 on magnet end part 15 and magnet thickness β2 on magnet central part 16. Specifically, bonded magnet 14 is configured such that resistance to demagnetization D1 of magnet central part 16 and resistance to demagnetization D2 of magnet end part 15 become equal to each other. To make resistance to demagnetization D1 and resistance to demagnetization D2 equal to each other, bonded magnet 14 is adjusted such that the total amounts of magnet powders included in the respective parts are equal to each other.

If resistance to demagnetization D1 and resistance to demagnetization D2 are equal to each other, the magnetic characteristics of bonded magnet 14 become uniform.

That is, in the case where the magnetic characteristics of bonded magnet vary, it is considered, for example, that demagnetization occurs on the portion of the bonded magnet where the magnetic characteristics are deteriorated.

In view of this, if the magnetic characteristics of bonded magnet 14 are made uniform as described above, the occurrence of problems such as demagnetization can be prevented.

As illustrated in FIGS. 1 and 3, when a current flows through winding 43 wound around stator 40, a magnetic flux is generated from winding 43. On the other hand, bonded magnets 14 generate magnetic fluxes of the magnetic components. Magnetic force generated by the interaction of these magnetic fluxes generates rotary torque for rotating rotor 10.

In this case, demagnetizing field is applied to bonded magnet 14 in the direction of reducing the magnetic flux of bonded magnet 14 from winding 43 on the portion of magnet hole 13 near the side of outer circumferential surface 11b. Therefore, bonded magnet 14 is required to increase resistance to demagnetization so as not to generate demagnetization.

In principle, the resistance to demagnetization of bonded magnet 14 increases in proportion to the magnet thickness. Therefore, the resistance to demagnetization of bonded magnet 14 can be increased by increasing the magnet thickness. However, if the magnet thickness is increased, the amount of magnet powders to be used for bonded magnet 14 is increased, which increases cost.

In view of this, in rotor 10 in the present exemplary embodiment, only the magnet thickness of bonded magnet 14 on magnet end part 15 where demagnetizing field is applied is increased. Thus, in rotor 10, the magnet thickness of bonded magnet 14 is increased only on a portion which is required to have increased resistance to demagnetization. In other words, rotor 10 according to the present exemplary embodiment enables an increase in resistance to demagnetization of bonded magnet 14 by increasing magnet powders at minimum to the optimum portion which is required to have increased resistance to demagnetization.

Accordingly, a motor having excellent magnetic characteristics can be provided at low cost without increasing the size of motor 100 by using rotor 10 according to the present exemplary embodiment.

Note that, in the above exemplary embodiment, the number of poles of rotor 10 is six. That is, the above exemplary embodiment indicates that the number of magnet holes 13 is six. The technical scope of the present invention is not limited to this number. When n is defined as a natural number, and if the number of poles of rotor 10 is 2n, the technical scope of the present invention encompasses rotor 10 having the present configuration.

In addition, the motor described above has a specification of 6-pole 9-slot concentrated winding. According to the technical scope of the present invention, the similar operation and effect can be obtained, even if other specifications are used. For example, the technical scope of the present invention encompasses a concentrated winding motor with other combinations. Further, the technical scope of the present invention also encompasses a distributed winding motor or a wave winding motor with respect to a winding of a slot.

In addition, similarly, the shape of bonded magnet 14 is not limited to the above-described shape. For example, the cross-section of bonded magnet 14 orthogonal to shaft center 12a may have a V shape or a U shape. If so, the similar operation and effect can be obtained.

### INDUSTRIAL APPLICABILITY

The interior permanent magnet rotor according to the present invention and a motor using this rotor are widely applicable to motors using permanent magnets, such as electrical apparatuses or industrial machines.

### REFERENCE MARKS IN THE DRAWINGS

10: rotor (interior permanent magnet rotor)
11: rotor core
11a: steel plate
11b: outer circumferential surface
11c, 11d: end face
12: rotary shaft
12a: shaft center
13: magnet hole
14: bonded magnet
14a: mixture
15: magnet end part
15a: end part
16: magnet central part
16a: central part
17, 18: arc
17a: convex surface
18a: concave surface
20: d-axis magnetic flux path
21: q-axis magnetic flux path
30: bearing
40: stator
41: stator core
42: insulator
43: winding
44: teeth
50: gate
100: motor

1. A motor comprising:
a stator including:
a winding through which a drive current flows; and
a stator core around which the winding is wound; and
a rotor including:
a rotary shaft;
a rotor core which is mounted to the rotary shaft to form a columnar body in a direction of a shaft center of the rotary shaft, and includes an outer circumferential surface formed along the shaft center and a plurality of magnet holes located along the outer circumferential surface,
each of the magnet holes having: a convex surface located on a side of the rotary shaft;
and a concave surface located on a side of the outer circumferential surface,
each of the magnet holes having a shape of projecting from the outer circumferential surface toward a position where the rotary shaft is located, and being configured such that a distance α1 between the convex surface and the concave surface on an end part of the magnet hole located on the side of the outer circumferential surface is larger than a distance β1 between the convex surface and the concave surface on a central part of the magnet hole located on the side of the rotary shaft; and
each of a plurality of bonded magnets which is filled in each of the plurality of magnet holes, and formed such that a thickness α2 of a magnet component located on the end part in an oriented direction is larger than a thickness β2 of a magnet component located on the central part in an oriented direction,
wherein the rotor has:
a plurality of d-axis magnetic flux paths that generates magnet torque, out of rotary torques generated on the rotor due to a rotating magnetic field generated by the stator, when the drive current flows through the winding; and
a plurality of q-axis magnetic flux paths that generates reluctance torque out of the rotary torques,
wherein each of the d-axis magnetic flux paths is located to cross each of the plurality of bonded magnets, and each of the q-axis magnetic flux paths is located along each of the plurality of bonded magnets.

2. The motor according to claim 1, wherein, in each of the plurality of bonded magnets, a density of the magnet located on the end part is lower than a density of the magnet located on the central part.

3. The motor according to claim 1, wherein the bonded magnets are filled in the plurality of magnet holes through an insert die, and when a density of one of the bonded magnet filled in a point P1 is defined as X, a distance from a point P2 where a gate included in the insert die is located to the point P1 is defined as Y, and a theoretical material density of the bonded magnet is defined as C, a decrease rate A of a density of the bonded magnet is represented by A=X/(Y×C), and the thickness β2 satisfies β2=A×α2.

4. The motor according to claim 1, wherein, in each of the bonded magnets, resistance to demagnetization D1 of a magnet central part located on the central part and resistance to demagnetization D2 of a magnet end part located on the end part are equal to each other.

5. The motor according to claim 1, wherein each of the plurality of magnet holes has an arc shape of projecting from the outer circumferential surface toward a position where the rotary shaft is located, and a radius R1 forming an arc included in the concave surface is smaller than a radius R2 forming an arc included in the convex surface.

6. The motor according to claim 5, wherein the arc included in the concave surface has two or more different curvatures.
